(19) United States
(12) Patent Application Publication
(10) Pub. No.: US 2008/0058242 A1
(43) Pub. Date: Mar. 6, 2008

(54) Cleaning fluid

(75) Inventors: Yuji Yoshinari, Matsuyama-shi (JP); Masaki Takai, Matsuyama-shi (JP); Makoto Hatori, Matsuyama-shi (JP); Daisuke Yamamoto, Matsuyama-shi (JP)

Correspondence Address: BIRCH STEWART KOLASCH & BIRCH, PO BOX 747, FALLS CHURCH, VA, 22040-0747, US

(73) Assignee: Miura Co., Ltd.

(21) Appl. No.: 11/892,769

(22) Filed: Aug. 27, 2007

(30) Foreign Application Priority Data
Sep. 4, 2006 (JP) 2006-238581

(51) Int. Cl. C11D 17/08

(52) U.S. Cl. 510/405

(57) ABSTRACT

The cleaning fluid, which is easily mass-produced, low priced, and safe and is also free from chemical substances contains water from which polyvalent cations are removed and to which sodium ions are added. When the cleaning fluid is applied to an object to be cleaned, stain adhered onto the object can be removed by action of the water. The object washed with the cleaning fluid is free from remnant of chemical substances, as is often not the case when washed with a cleaning fluid using chemical-substances such as a surfactant, and is therefore safe. Furthermore, since water stain or scale hardly remains on the object washed, new stain is not easily attached. Accordingly, the cleaning fluid is particularly effective when it is used as a cleaning fluid for kitchen sinks, tableware, foods, washstands, bathrooms, toilets, vehicles and clothes.

### TECHNICAL FIELD

The present invention relates to a cleaning fluid, in particular, an aqueous cleaning fluid.

### BACKGROUND ART

In cleaning of kitchen sinks, tableware, bathrooms and sanitary installations such as toilets, water-soluble cleaning fluids containing chemical substances such as surfactants and pH adjustment agents are generally in heavy usage. The cleaning steps to be taken in case of using a cleaning fluid of this kind is generally to have an aqueous cleaning fluid absorbed in a cleaning tool such as a cloth and sponge, to foam the fluid and rub an object to be cleaned, and subsequently to rinse the object with water. Stain adhered to the object to be cleaned comes onto a surface by the effect of a surfactant, and is rinsed off from the object upon rinsing with water.

The above-described cleaning work requires two-staged processes washing with an aqueous cleaning fluid and rinsing with water. Particularly, the water rinsing process requires a careful work, because the purposes thereof include rinsing off chemical substances such as a surfactant originated from an aqueous cleaning fluid, in addition to rinsing off stain coming onto a surface of an object to be cleaned. Accordingly, the above-described cleaning work takes a lot of labor and needs a large amount of water upon rinsing with water.

On the other hand, electrolytic water is known as a cleaning fluid that gives high cleaning effect without using chemical substances such as a surfactant. For example, Japanese Unexamined Patent Publication (Kokai) No. 10-192860 (JP 1998-192860A) describes alkaline electrolytic water having pH 8 to 13. The alkaline electrolytic water is prepared by electrolysis of tap water added an electrolyte such as sodium chloride. In case of using such electrolytic water, an object to be cleaned is rubbed with a cleaning tool, while applying electrolytic water to the object.

However, since electrolytic water is produced through the steps comprising addition of an electrolyte to raw water such as tap Water and electrolysis of the raw water to which the electrolyte is added, a mass-production of electrolytic water is difficult without relying on a complex and large-scale apparatus. In addition, producing electrolytic water can be costly owing to an energy source required for electrolysis.

An object of the present invention is to realize a cleaning fluid, which is free from chemical substances and is safe and also can be mass-produced at low cost.

### SUMMARY OF THE INVENTION

A cleaning fluid of the present invention contains water from which polyvalent cations are removed and to which sodium ions are added. When the cleaning fluid is applied to an object to be cleaned, stain adhered onto the object can be removed by the action of the water. The object cleaned with the cleaning fluid retains no residual chemical substances such as a surfactant, as is often not the case when cleaned with a cleaning fluid that contains chemical substances. Therefore, the object cleaned with the cleaning fluid is safe, and also hard to attract new stain because of less water stain or scale remaining thereon. As a result, the cleaning fluid enables to clean an object to be cleaned more safely than a cleaning fluid containing chemical substances such as a surfactant does.

Since the cleaning fluid is mass-produced more easier than electrolytic water and is provided at low cost, it is particularly effective when the cleaning fluid is used for, for example, kitchen sinks, tableware, foods, washstands, bathrooms, toilets, vehicles and clothes.

Other objects and effects of the present invention will be described in detail hereinafter.

### DESCRIPTION OF THE PREFERRED EMBODIMENT

The cleaning fluid of the present invention contains water from which polyvalent cations are removed and to which sodium ions are added (hereafter such water is called “functional water” in some cases). The functional water is obtained by treatment of water (raw-water), such as tap, ground, river, lake and well water, with a cation exchange resin. In this treatment, a calcium ion (bivalent cation), magnesium ion (bivalent cation), copper ion (bivalent cation), iron ion (bivalent and trivalent cations), aluminum ion (trivalent cation) and the like contained in the raw water are exchanged with a sodium ion (monovalent cation) contained in the cation exchange resin.

The cation exchange resin used for the treatment of raw water is a synthetic resin, wherein a suflonic acid group is introduced to a matrix of a cross-linked three dimensional polymer such as a copolymer of styrene and divinylbenzene, and the sulfonic acid group forms a sodium salt.

In the functional water, it is preferable that a concentration of polyvalent cations is commonly adjusted to less than 0.2 mmol/l, and particularly preferable to be adjusted to less than the measurement limit, which signifies substantially zero level. Here, the concentration of polyvalent cations denotes a concentration measured on the basis of ICP emission spectroscopic analysis.

On the other hand, in the functional water, it is preferable that a concentration of a sodium ion is commonly adjusted to 0.3 mmol/l or more and less than 500 mmol/l, and more preferable to be adjusted to 0.5 mmol/l or more and less than 200 mmol/l. Here, the concentration of a sodium ion denotes a concentration measured on the basis of ICP emission spectroscopic analysis.

The cleaning fluid of the present invention may contain some other components other than the above functional water to the extent that they do not spoil the purposes of the present invention. Examples of the other components include fragrant materials such as a grapefruit oil, spearmint oil, nutmeg oil and mandarin oil. Two kinds or more of the fragrant materials can be used in combination.

The cleaning fluid of the present invention is easily prepared through the processes of treating raw water with the above-mentioned cation exchange resin, and then to the resultant functional water properly adding the above other components according to need. Accordingly, the cleaning fluid is mass-produced more easily as compared with electrolytic water, and also produced at low cost.

An object to be cleaned with the cleaning fluid of the present invention is not particularly limited. Examples thereof include sanitary installations such as kitchen sinks, washstands, bathrooms (particularly, bathtubs, floors, walls, drain outlets, plated parts such as faucets and the like) and toilets (particularly, toilet bowls and floors); tableware (such as earthenware, porcelain, glass ware, plastic ware, metallic ware and metallic cutlery); food such as vegetables and fruits; vehicles (such as automobiles, two-wheeled motor vehicles and railroad vehicles); and clothes.

When sanitary installations or vehicles are washed by using the cleaning fluid of the present invention, the cleaning fluid is commonly watered to runoff over an object to be cleaned. At that time, regions necessary to be cleaned can be rubbed or wiped with a cleaning tool such as a cloth, sponge or brush, while the cleaning fluid is watered to run off over the object. The object washed by using the cleaning fluid in such a way may be dried as it is, but water can be wiped off, if necessary.

When tableware or food is washed, a region necessary to be cleaned is commonly rubbed or wiped with a cleaning tool such as a kitchen cloth and sponge, while the cleaning fluid is watered to run off over an object to be cleaned. It is also available that tableware or food is immersed in the cleaning fluid of the present invention, and then the tableware or food is rinsed with the cleaning fluid of the present invention. The tableware and food cleaned by using the cleaning fluid in such a way may be dried as it is, but water can be wiped off, if necessary.

In case of washing clothes, generally, it is preferable that clothes are immersed in the cleaning fluid of the present invention, squeeze washed, and then rinsed with the cleaning fluid of the present invention. Cleaning of clothes in such a manner can be performed manually or by a washing machine.

Since the cleaning fluid of the present invention consists primarily of the above-mentioned functional water, stain adhered onto an object to be cleaned can be brought up to a surface by working of the functional water, and thus the stain can be removed from the object. Therefore, the object washed with the cleaning fluid of the present invention retains no residual chemical substances, as is often not the case when washed with a cleaning fluid that contains chemical substances such as surfactant, and is safe. Particularly, the cleaning fluid of the present invention can wash tableware and food safely.

In addition, an object washed with the cleaning fluid of the present invention tends to maintain a cleaner state over a longer period of time. This is because water stain or scale, which becomes a nest of various germs or a cause of new stain to adhere, is hard to remain on the object washed. Such an effect is certain to be attained when the cleaning fluid of the present invention is always used to wash an object.

In the above-described embodiment, water from which polyvalent cations are removed and to which sodium ions are added is used as functional water, but the functional water may be such that polyvalent cations are removed and alkali metal ions other than sodium ions, such as potassium ions, are added. This functional water can be obtained by treating raw water using, the above cation exchange resin, wherein a sulfonic acid group forms an alkali metal salt such as a potassium salt.

### EXAMPLES

### Examples 1 to 9 and Comparative Examples 1 to 9

A test piece, all over which a model contamination solution was adhered, was fully immersed in a cleaning fluid at 30° C., and then allowed to stand for 10 minutes. The test pieces and cleaning fluids used herein are as follows, and combinations of the test piece and the cleaning fluid are shown in Table 1.

### [Test Pieces]

### <Test Piece 1>

A red colorant (Sudan III) is added to a mixture of beef tallow and soybean oil to obtain a model contamination solution, and a rectangular plate material (76 mm×26 mm×1.0 mm) made of borosilicate glass, was immersed therein, thereby adhering the model contamination solution on the entire surface of the plate material.

### <Test Piece 2>

Gelatin was dissolved in water to prepare a model contamination solution, and a rectangular plate material (76 mm×2.6 mm×1.0 mm) made of borosilicate glass was immersed therein, thereby adhering the model contamination solution on the entire surface of the plate material.

### <Test Piece 3>

Albumin was dissolved in water to obtain a model contamination solution, and a rectangular plate material (76 mm×26 mm×1.0 mm) made of borosilicate glass was immersed therein, thereby adhering the model contamination solution on the entire surface of the plate material.

### [Cleaning Fluids]

### <Cleaning Fluid 1>

A fluid, which consists of water prepared by treating tap water supplied in Matsuyama city, Ehime Japan, with a cation exchange resin, wherein the water satisfies the following conditions: the concentration of polyvalent ions is less than 0.2 mmol/l; and the concentration of a sodium ion is 0.3 mmol/l or more and less than 500 mmol/l.

### <Cleaning Fluid 2>

A fluid, which consists of tap water supplied in Matsuyama city, Ehime Japan.

### <Cleaning Fluid 3>

A fluid, which is prepared by adding and dissolving 0.8 g of a soap (trade name of “Nantaro Powder Soap” manufactured by Miura Co., Ltd.) per liter of the cleaning fluid 1.

### <Cleaning Fluid 4>

A fluid, which is prepared by adding and dissolving 0.8 g of a soap (trade name of “Nantaro Powder Soap” manufactured by Miura Co., Ltd.) per liter of the cleaning fluid 2.

### <Cleaning Fluid 5>

A fluid, which is prepared by adding and dissolving 0.75 ml of a synthetic detergent (trade name of “Family Compact” manufactured by Kao Corporation) per liter of the cleaning fluid

### <Cleaning Fluid 6>

A fluid, which is prepared by adding and dissolving 0.75 ml of a synthetic detergent (trade name of “Family Compact” manufactured by Kao Corporation) per liter of the cleaning fluid 2.

### Evaluation 1

In Examples 1 to 9 and Comparative Examples 1 to 9, a test piece was taken out of a cleaning fluid ten minutes after immersion had started and cleaning ratio of the test piece was determined. The cleaning ratio was determined by the following method. The results are shown in Table 1.

### [Cleaning Ratio of Test Piece 1]

A mixture of beef tallow and soybean oil adhering to the test piece was extracted in chloroform, and an amount of the mixture contained in the extraction solution was determined by absorption spectrophotometry (510 nm). The cleaning ratio (%) was calculated by the formula: (A−B)/A×100 (wherein A represents the amount of mixture adhering to the test piece before washing; and B represents the amount of mixture contained in the extraction solution).

### [Cleaning Ratio of Test Piece 2]

The test piece was immersed in an aqueous solution of NaOH (0.1 N) at 85±5° C., and treated for 120 minutes. Then, the amount of gelatin contained in the NaOH aqueous solution was determined by absorption spectrophotometry (562 nm) using BCA Protein Assay Kit manufactured by Pierce Chemical Company. The cleaning ratio (%) was calculated by the formula: (A−B)/A×100 (wherein A represents the amount of gelatin adhering to the test piece before washing; and B represents the amount of gelatin contained in the NaOH aqueous solution).

### [Cleaning Ratio of Test Piece 3]

The test piece was immersed in an aqueous solution of NaOH (0.1 N) at 85±5° C., and treated for 120 minutes. Then, the amount of albumin contained in the NaOH aqueous solution was determined by absorption spectrophotometry (562 nm) using BCA Protein Assay Kit manufactured by Pierce Chemical Company. The cleaning ratio (%) was calculated by the formula: (A−B)/A×100 (wherein A represents the amount of albumin adhering to the test piece before washing; and B represents the amount of albumin contained in the NaOH aqueous solution).

TABLE 1

| | | | Cleaning |
|---|---|---|---|
| | Test piece | Cleaning fluid | ratio (%) |
| Example 1 | 1 | 1 | 71.4 |
| Comparative | 1 | 2 | 42.7 |
| Example 1 | | | |
| Example 2 | 1 | 3 | 99.4 |
| Comparative | 1 | 4 | 21.9 |
| Example 2 | | | |
| Example 3 | 1 | 5 | 99.7 |
| Comparative | 1 | 6 | 99.5 |
| Example 3 | | | |
| Example 4 | 2 | 1 | 77.3 |
| Comparative | 2 | 2 | 72.3 |
| Example 4 | | | |
| Example 5 | 2 | 3 | 96.9 |
| Comparative | 2 | 4 | 94.7 |
| Example 5 | | | |
| Example 6 | 2 | 5 | 90.6 |
| Comparative | 2 | 6 | 90.1 |
| Example 6 | | | |
| Example 7 | 3 | 1 | 99.5 |
| Comparative | 3 | 2 | 84.6 |
| Example 7 | | | |
| Example 8 | 3 | 3 | 99.8 |
| Comparative | 3 | 4 | 99.1 |
| Example 8 | | | |
| Example 9 | 3 | 5 | 99.9 |
| Comparative | 3 | 6 | 95.1 |
| Example 9 | | | |

### Example 10

In accordance with “JEMA-HD84, A method for performance measurement of dishes washing/drying machine”, which is a voluntary standard stipulated by the Japan Electrical Manufacturer's Association, a group of stained tableware (total number of stained tableware=56) were prepared with the content below. After leaving the stained tableware for 1 hour, they were washed by an automatic dishes washing/drying machine (trade name of “NP-40SX2” manufactured by Matsushita Electric Industrial Co., Ltd.) without using a detergent. The above cleaning fluid 1 was supplied to the automatic dishes washing/drying machine as washing water.

### A group of Stained Tableware

| Tableware | Number | | State of stain |
|---|---|---|---|
| Large plate | 4 | pieces | Spread a mixture of curried rice and |
| | | | raw egg, and leave about 10 rice grains |
| | | | on the plate |
| Middle | 2 | Pieces | Chop up pork cutlet with pork cutlet sauce |
| plate | | | thereover, and spread it over the plate |
| Small plate | 4 | pieces | Chop up hum and egg, and spread it over |
| | | | the plate |
| Rice bowl | 6 | pieces | Spread rice in the bowl |
| Soup bowl | 6 | pieces | Rinse the bowl with miso soup |
| Teacup | 4 | pieces | Rinse the cup with green tea |
| Glass | 6 | pieces | Rinse the glass with tomato juice |
| Chopsticks | 12 | pairs | Stained at the time when the rice bowls were |
| | | | stained, and adhere a rice grain on the tip |
| | | | of the chopstick |
| Fork | 4 | pieces | Stained at the time when the middle and |
| | | | small plates were stained |
| Spoon | 4 | pieces | Stained at the time when the large plates |
| | | | were stained |
| Knife | 4 | pieces | Stained at the time when the middle and |
| | | | small plates were stained |

### Comparative Example 10

A group of stained tableware was washed in the same manner as in Example 10, except for using the cleaning fluid 2 as washing water.

### Evaluation 2

With regard to Example 10 and Comparative Example 10, in accordance with “JEMA-HD84, A method for performance measurement of dishes washing/drying machine”, which is a voluntary standard stipulated by the Japan Electrical Manufacturer's Association, the finishing state of the group of stained tableware after washing was evaluated based on the criteria below, and the cleaning ratio was calculated by the following equation (1). In the equation (1), “Number” denotes a number of relevant stained tableware, and “Total number” denotes a total number of stained tableware. The results are shown in Table 2.
Rate A: Cleaned to the extent that no stain adherence is visually observed, and there is no region of oil film and cloud.
Rate B: Cleaned to the extent that the tableware can be used without washing again, and the state of stain adherence and cloud is such extent that is described in (a) and (b).

(a) A number of regions where a stain adheres is 4 or less, and also a total adherence area of a stain is 4 mm² or less.

(b) A total cloud area is 1 cm² or less.
Rate C: Cleaned to the extent that neither rate A nor rate B is gained.

TABLE 2

| | |
|---|---|
| | (1) |
| $Cleanig ratio ( \% ) = \frac{( Number of rate A ) \times 2 + ( Number of rate B )}{Total number \times 2} \times 100$ | |

| | Finishing state (number) | | | Cleaning |
|---|---|---|---|---|
| | Rate A | Rate B | Rate C | ratio (%) |
| Example 10 | 22 | 15 | 19 | 53 |
| Comparative | 14 | 5 | 37 | 29 |
| Example 10 | | | | |

### Example 11

A test piece was immersed in the cleaning fluid 1 for 1 minute and taken out, followed by drying it in an oven at 90° C. for 10 minutes. The treatment was repeated 10 times. The test piece used here was a rectangular plate material (76 mm×26 mm×1.0 mm) made of borosilicate glass.

### Comparative Example 11

A test piece was treated in the same manner as in Example 11, except for using the cleaning fluid 2 instead of the cleaning fluid 1.

### Evaluation 3

In Example 11 and Comparative Example 11, an area percentage of water spots, which adhered to the test piece after treatment, was studied. The percentage was 15% in Example 11, while 40% in Comparative Example 11. The area percentage of water spots was obtained as follows. First, the test piece after treatment was photographed, and which was photocopied on two sheets of paper. Next, the whole image of the test piece on one sheet of photocopied paper was cut out with scissors and it was weighed (weight A), while the images of water spots on the other sheet of photocopied paper were cut out with scissors and they were weighed (weight B). The area percentage of water spots conforms to the weight ratio (weight B/weight A). According to the result, it was learned that the cleaning fluid 1 tends not to leave water stain or scale on a test piece as compared to the cleaning fluid 2.

### Examples 12, 13

Using the cleaning fluid 1 adjusted at a temperature of 60° C., stained clothes (10 pieces) were washed by “tergotometer” described in JIS K 3304 “Test Method for Soaps”. The washing conditions by the “tergotometer.” are as follows. The stained clothes used here are as follows too.

### [Washing Conditions]

Rotation rate: 80 rpm
Wash time: 10 minutes
Liquor ratio: 1:300 (3.4 g of stained clothes (equivalent to 10 pieces of stained clothes) to 1 liter of water)
Temperature: 60° C.

### [Stained Clothes]

### <Stained Cloth 1>

The stained cloth 1 was prepared by applying a 33.5 mg/ml chloroform solution of palmitic acid to a cotton cloth with a size of 5×5 cm in an amount of 40 μ1 each at 5 spots, totaling 200 μl, and drying it naturally. The stain (palmitic acid) applied to the cotton cloth is a model of sebum. The amount of palmitic acid applied to the cotton cloth was 6.7 mg, equivalent to 2% of the cloth weight.

### <Stained Cloth 2>

The stained cloth 2 was prepared by applying a 33.5 mg/ml chloroform solution of tripalmitin to a cotton cloth with a size of 5×5 cm in an amount of 40 μ1 each at 5 spots, totaling 200 μl, and drying it naturally. The stain (tripalmitin) applied to the cotton cloth is a model of sebum. The amount of tripalmitin applied to the cotton cloth was 6.7 mg, equivalent to 2% of the cloth weight.

### Comparative Examples 12, 13

The stained clothes were washed in the same manner as in Examples 12 and 13, using the cleaning fluid 2 instead of the cleaning fluid 1.

### Evaluation 4

With regard to the stained clothes washed in Examples 12 and 13 and Comparative Examples 12 and 13, removal ratios of stain were studied. The removal ratios were obtained as follows. First, any given 5 pieces of stained clothes selected from 10 pieces of stained clothes after washing, 0.1 g of heptadecanoic acid serving as an internal standard substance, 49 ml of 0.5 mol/l NaOH-methanol solution and a couple of boiling stones were placed in a round bottom flask. A Liebig condenser was connected to the round bottom flask to carry out extraction of palmitic acid or tripalmitin from the stained clothes as well as saponification at 80° C. for 30 minutes. Then, about 10 ml of the extraction solution was transferred into a 50 ml round bottom flask, to which 5 ml of boron trifluoride methanol complex—methanol solution and a couple of boiling stones were added, and a methyl esterification treatment was carried out at 90° C. Two minutes after the methyl esterification treatment had started, 5 ml of hexane was added from the upper part of the condenser, and which was kept boiling for 1 minute. After cooling, a saturated sodium chloride solution was added up to the opening of the round bottom flask to collect the upper hexane layer. The hexane layer was-dehydrated with anhydrous sodium sulfate. The sample prepared by the above-described procedure was analyzed by gas chromatography to determine an amount of palmitic acid or tripalmitin extracted from the stained clothes washed. Based on the measurement result, the removal ratio was calculated by the following equation (2). In the equation (2), “Stain weight before washing” denotes a total stain weight attached to the 5 pieces of stained clothes, and “Stain weight after washing” denotes a total stain weight extracted from the 5 pieces of stained clothes washed. The results are shown in Table 3. The gas chromatography analysis was conducted by an apparatus with the trade name of “GC-17A” manufactured by Simadzu Corporation, and the analytic conditions were determined as follows.
Column: Trade name of “DB-WAX” manufactured by J & W Corp. (length 30 m; inside diameter 0.25 mm; film thickness 0.25 μm)
Column temperature: After maintained at 50° C. for 2 minutes, the temperature was raised to 250° C. at a rate of 10° C./min, and then maintained at 250° C. for 8 minutes.
Carrier gas and flow rate: Helium, 1.9 ml/min
Injector: 250° C., split ratio=1:50
Detector: FID (270° C.);
Makeup gas: Nitrogen

TABLE 3

| | |
|---|---|
| | (2) |
| $Removal ratio ( \% ) = \frac{\begin{matrix}( Stain weight before washing ) - \\ ( Stain weight after washing )\end{matrix}}{Stain weight before washing} \times 100$ | |

| | Stained cloth | Removal ratio (%) |
|---|---|---|
| Example 12 | 1 | 15.4 |
| Comparative Example 12 | 1 | 3.1 |
| Example 13 | 2 | 8.5 |
| Comparative Example 13 | 2 | 4 |

### Example 14

Using a drum-type home washing machine (trade name of “TW-742EX” manufactured by Toshiba Corporation), 32 pieces of clothes consisting of 4 different kinds of artificially stained clothes of 8 pieces and 3.5 kg of laundry in total (sheet, bath towel, face towel and yukata (cotton wear)) were washed simultaneously without using a detergent. The washing machine was programmed such that a washing process, a first rinsing process, a second rinsing process, a third rinsing process, a spin-drying process and a drying up process were implemented in this order. In the washing process and the respective rinsing processes, the cleaning fluid 1 was used. In the washing process, the cleaning fluid 1 was adjusted at a temperature of 60° C.

The stained clothes of 4 different kinds used herein are as follows.

### <Stained Cloth 3>

A wet-type artificially stained cloth serving as a model of dirty collar. Specifically, it is described in the Japanese Industrial Standards JIS C 9606 “Detergency test of electric washing machine”.

### <Stained Cloth 4>

An artificially stained cloth manufactured by EMPA (trade name of “EMPA101”), which is a model cloth stained with a mixture of olive oil and carbon black.

### <Stained Cloth 5>

An artificially stained cloth manufactured by EMPA (trade name of “EMPA111”), which is a model cloth stained with blood.

### <Stained Cloth 6>

An artificially stained cloth manufactured by EMPA (trade name of “EMPA112”), which is a model cloth stained with a mixture of cocoa powder, sugar and milk.

### Comparative Example 14

A washing was conducted in the same manner as in Example 14, except for using the cleaning fluid 2 in the washing process and the respective rinsing processes.

### Evaluation 5

In Example 14 and Comparative Example 14, cleaning efficiency of the respective stained clothes was studied. The cleaning efficiency of the stained cloth 3 was calculated by the following equation (3), and that of the stained clothes 4 to 6 was calculated by the following equation (4). The results are shown in Table 4. The cleaning efficiency shown in Table 4 is a mean value of 8 pieces of the respective kind of stained clothes.

$$Cleaning efficiency ( \% ) = \frac{Reflectance after washing ( \% ) - Reflectance before washing ( \% )}{Reflectance of white cloth ( \% ) - Reflectance of before washing ( \% )} \times 100 \qquad ( 3 )$$

In the equation (3), the white cloth is a cotton cloth for cleaning test designated by the Japan Oil Chemists' Society. Reflectance denotes a reflectance at 530 nm. The reflectance was determined by using a reflectometer. (trade name of “Spectroscopic Colorimeter SE2000” manufactured by Nippon Denshoku Industries).

$$Cleaning efficiency ( \% ) = \frac{Y \text{-} value after washing - Y \text{-} value before washing}{Y \text{-} value of white cloth - Y \text{-} value before washing} \times 100 \qquad ( 4 )$$

In the equation (4), the white cloth is identical to that in the equation (3). The Y-value denotes a Y-value of tristimulus value (that is, brightness of color). The Y-value was determined using the above reflectometer.

TABLE 4

Cleaning efficiency (%)

| | (1) | (2) | (3) | (4) |
|---|---|---|---|---|
| | Stained | Stained | Stained | Stained |
| | cloth 3 | cloth 4 | cloth 5 | cloth 6 |
| Example 14 | 18 | 12 | 36 | 15 |
| Comparative | 9 | 5 | 26 | 0 |
| Example 14 | | | | |

The present invention can be practiced in other various forms without departing from the spirit and principal features thereof. In view of this, the embodiments or examples described above merely serve as exemplification in every respect and should not be construed restrictively. A scope of the present invention is defined by claims, and is by no means bound by the text of the specification. Furthermore, all modifications and alternations belonging to the equivalent scope of the claims fall within the scope of the present invention.

1. A cleaning fluid containing water from which polyvalent cations are removed and to which sodium ions are added.

2. The cleaning fluid according to claim 1, which is used for kitchen sinks.

3. The cleaning fluid according to claim 1, which is used for tableware.

4. The cleaning fluid according to claim 1, which is used for foods.

5. The cleaning fluid according to claim 1, which is used for washstands.

6. The cleaning fluid according to claim 1, which is used for bathrooms.

7. The cleaning fluid according to claim 1, which is used for toilets.

8. The cleaning fluid according to claim 1, which is used for vehicles.

9. The cleaning fluid according to claim 1, which is used for clothes.
